(19) United States
(12) Patent Application Publication
(10) Pub. No.: US 2020/0237611 A1
(43) Pub. Date: Jul. 30, 2020

(54) MULTI-PURPOSE PHYSIOLOGICAL TREATMENT TOOL

(71) Applicant: James William Tucker, Spokane Valley, WA (US)

(72) Inventor: James William Tucker, Spokane Valley, WA (US)

(21) Appl. No.: 16/261,271

(22) Filed: Jan. 29, 2019

(51) Int. Cl. A61H 23/00

(52) U.S. Cl. CPC A61H 23/00; A61H 2201/1657

(57) ABSTRACT

Multi-purpose physiological treatment tools may include a head covering and coupled to a post. The head may be constructed of at least partially of a polymeric material having a therapeutically effective durometer. The head may have a number of designs and configurations that may be used for treating different body parts and/or body tissues. An example head may have three or more at least partially concaved edges with two surfaces between the edges. Another example head may have two edges with a surface between the edges. Another example head may have a large surface area that is at least partially concaved.

### BACKGROUND

Myofascial release techniques find applicability in many fields, including massage therapy, physical therapy, and chiropractic care, for example to correct or improve the health of multiple body parts and tissues such as muscles and fascia. When muscles are sore or damaged, they may contract. Contracted muscles may lead to immobility and pain in the area of the contracted muscle. Fascia is a connective tissue that covers muscles. Fascia can become restrictive from, for example, overuse, trauma, and inflammation, which may lead to adhesion formation, further muscle spasm, and decreased blood flow to the corresponding muscle. Myofascial release techniques generally focus on relaxing contracted muscles and restricted fascia by stimulating proprioceptors and mechanoreceptors in the muscle of interest. Conventionally, myofascial release techniques include a therapist or chiropractor repeatedly pressing or “kneading” a muscle of interest until release is achieved. However, these techniques are laborious for the health care provider, often result in painful therapy for the patient, and allow the patient's reflexes to work against the health care provider, leading at times to less than favorable therapeutic results. Additionally, circulatory therapy may be beneficial, such as for “warming up” muscles and/or promoting the passage of interstitial fluid and blood through the body. However, current circulatory techniques do not provide enough therapeutic effect and/or are too time-consuming. Also, little has been done to develop and/or improve the interface of percussion devices with muscular, myofascial, and circulatory therapy.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a perspective view of an example multi-purpose physiological treatment tool.

FIG. 2 illustrates a side view of the example multi-purpose physiological treatment tool shown in FIG. 1.

FIG. 3 illustrates a top view of the example multi-purpose physiological treatment tool shown in FIG. 1.

FIG. 4 illustrates a perspective view of another example multi-purpose physiological treatment tool.

FIG. 5 illustrates a side view of the example multi-purpose physiological treatment tool shown in FIG. 4.

FIG. 6 illustrates a top view of the example multi-purpose physiological treatment tool shown in FIG. 4.

FIG. 7 illustrates a perspective view of another example multi-purpose physiological treatment tool.

FIG. 8 illustrates a top view of the example multi-purpose physiological treatment tool shown in FIG. 7.

FIG. 9 illustrates a side view of an example multi-purpose physiological treatment tool and an oscillating device.

FIG. 10 illustrates a flow diagram of an example process by which a multi-purpose physiological treatment tool may be utilized.

### DETAILED DESCRIPTION

This overview, including section titles, is provided to introduce a selection of concepts in a simplified form that are further described below. The overview is provided for the reader's convenience and is not intended to limit the scope of the implementations or claims, nor the proceeding sections.

This disclosure describes example multi-purpose physiological treatment tools and methods of using the same.

As discussed above, myofascial release techniques can be laborious for the treating health care provider, can often result in painful therapy for the patient, which can allow the patient's reflexes to work against the health care provider, leading to less favorable therapeutic results. Additionally, circulatory treatment techniques do not provide enough therapeutic effect and/or are time consuming. Example multi-purpose physiological treatment tools and methods of using the same as described herein allow for myofascial release therapy, muscle tension reduction therapy, adhesion reduction, and circulatory therapy that is easier and quicker to perform by a health care professional, resulting in decreased pain to the patient, and inhibits the patient's reflexes to work against the health care provider. Additionally, the multi-purpose physiological treatment tools and methods described herein provide treatment for a wider range of body tissues and parts than could be achieved through conventional myofascial release and/or circulatory therapy techniques, diversifying myofascial release and circulatory therapy applicability. The tools described herein alleviate the shortcomings of current myofascial release techniques by utilizing one or more tips that may be composed at least partially of thermoplastic elastomer with molecular bonding capabilities made from, at least in part, amorphous thermoplastic pellets designed as described below. Individual ones of tips described herein may be received in an oscillating device, such as a reciprocating saw, and the health care professional may engage the oscillating device to repeatedly contact a desired location of the patient's body. The design of the one or more tips accompanied by the repeated oscillation against the patient's body may provide effective myofascial release and/or circulatory therapy in a reduced amount of treatment time. Additionally, in examples, use of the multi-purpose physiological treatment tools as described herein may achieve a scraping and/or plowing motion on a portion of the patient's body, which may result in soft tissue mobilization, pin and stretch, and/or plowing, that may help to release the body's healing compacity and/or in aiding the body to heal, such as removing scar tissue, kinks in the myofascial system, muscle tension, and/or mechanically removes inflammation.

In an example, an example multi-purpose physiological treatment tool may comprise a post that may have a distal end and a proximal end. The proximal end may be sized to be received by an oscillating device. The multi-purpose physiological treatment tool may also comprise a head, which may be constructed at least partially of a polymeric material. The polymeric material may cover at least a portion of the distal end of the post and may be coupled to the post. It should be understood that while the example heads described herein are described as being constructed of a polymeric material, the heads may additionally, or alternatively, be constructed of a metallic material. The head may have a durometer sufficient to provide a therapeutic effect to a desired location of the patient's body. The durometer may vary depending on the location of treatment, therapeutic effect, and/or clinical application desired by the health care provider. It should be understood that when durometer is used herein, it is used to describe the density and/or softness and/or hardness of the head portion of the one or more tools. It should be further noted that durometer scales may differ, sometimes widely, between those having ordinary skill in the art. Durometers and/or durometer ranges are provided herein by way of example. Equivalent durometers and/or durometer ranges with different measurement units and/or scales are also included in this disclosure. It should be understood that when materials are described herein, at least some of the materials to be used may include, metal, plastic, silicone, wood, rubber, and/or threaded beads.

In examples, a multi-purpose physiological treatment apparatus may comprise multiple tips. Individual ones of the multiple tips may have a proximal end sized to be received at least partially in an oscillating device. The tips may also be interchangeable and may be constructed at least partially of a polymeric material. The tips may also be constructed, instead, of a material that does not include polymeric material. The tips may be designed to have differing structures and/or designs to provide varying therapeutic effects to varying areas of the patient's body.

In examples, a method of using multi-purpose physiological treatment tools may comprise oscillating at least one of the tips on a desired portion of the patient's body. The oscillating may be accomplished by operation of an oscillating device with a tip received by the oscillating device. A health care provider may choose a tip, from the tips, that is designed for use on a specific portion of the patient's body and/or for treatment of specific tissue (e.g., muscle, tendon, ligament, bone, fascia, etc.). The health care provider may connect the chosen tip to the oscillating device. The health care provider may contact the tip with the body of the patient and enable the oscillating device to begin oscillation. The health care provider may exert a certain amount of force during oscillation depending on the chosen tip and desired therapeutic effect. The health care provider may change tips during a treatment session to treat additional areas of the body and/or additional tissues. The tips may comprise varying durometers and designs and be interchangeable without substantial effort or time. In examples, the multi-purpose physiological treatment tools described herein may have multiple surfaces and/or edges. Some of those surfaces and/or edges may be utilized by the health care provider for certain uses while other surfaces and/or edges may be utilized by the health care provider for other uses. For example, a given tip may have an edge portion that may be utilized by the health care provider in a scraping and/or plowing motion, while the same tip and/or another tip may have a flat and/or at least partially concaved portion that may be utilized by the health care provider for compression and/or percussion. It should be understood that when percussion therapies are described herein, those therapies include vibration-related therapies. It should be understood that whenever a health care provider is described as using the materials described herein, this disclosure includes any operator, whether a health care provider or otherwise. It should also be understood that whenever a patient is described herein, this disclosure includes any person and/or animal that is receiving treatment.

Multi-purpose physiological treatment tools according to this disclosure may be designed for a variety of applications, such as, for example, physical therapy, massage therapy, chiropractic care, veterinary care, and/or for use by a patient without aid from a health care provider. The multi-purpose physiological treatment tools according to this disclosure may be used on various parts of the body, including, for example, skeletal muscles, fascia, tendons, ligaments, and the connections between bone and any other connective tissue. It should be understood that while many of the examples provided herein illustrate the use of the multi-purpose physiological treatment tools on a human and/or by a health care provider, this disclosure also includes the design and use of the multi-purpose physiological treatment tools on animals and/or by a veterinarian and/or other animal health care provider and/or owner.

One or more examples of the present disclosure are illustrated in the accompanying drawings. Those of ordinary skill in the art will understand that the tools and methods specifically described herein and illustrated in the accompanying drawings are non-limiting examples and that the scope of these examples is defined solely by the claims. The features illustrated or described in connection with one example may be combined with the features of other examples. For example, design elements described with respect to one example may be incorporated, in whole or in part, into the design elements of another example. Such modifications and variations are intended to be included within the scope of the appended claims.

Additional details are described below with reference to several examples.

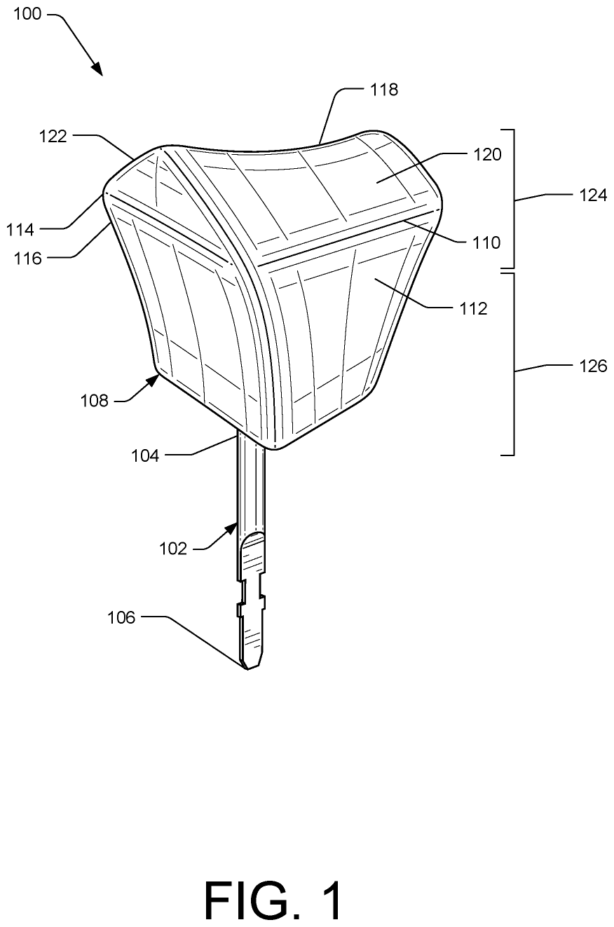

FIGS. 1-9 illustrate various examples of multi-purpose physiological treatment tools. Unless otherwise expressly stated, the sizes, shapes, and symbols used to describe the various components of the tools are used for illustration only and should not be used as limitations of the tools as described herein.

FIG. 1 is a perspective view of an example of a myofascial release tool 100. The tool 100 may include a post 102. The post 102 may have a distal end 104 and a proximal end 106. The proximal end 106 may be sized to be received by an oscillating device. In an example, the oscillating device may be any device that provides oscillating motion, such as, for example, a reciprocating saw, an oscillating saw, a jigsaw, or a sabre saw. The oscillating device may enable oscillation of a tip in a substantially linear motion from, for example, approximately 1 revolution per minute (RPM) to approximately 3,000 RPM. In other examples, the oscillation of the tip may be in a circular motion or a random motion. In still other examples, the oscillation of the tip may be in a sweeping motion, such that the oscillation causes the tip to move back and forth in a direction tangential to the oscillating device. In other examples, as used herein, RPM may be alternatively defined as strokes per minute. In an example, the oscillating device may oscillate at more than 3,000 RPM. For example, the oscillating device may oscillate at at least 3,000 RPM, at least 3,500 RPM, at least 4,000 RPM, at least 4,500 RPM, at least 5,000 RPM, or more. The post 102 may be tooled to include grooves, indents, and other configurations to allow the proximal end 106 to be received within a particular oscillating device. The post 102 may be tooled such that, when received by the oscillating device, the post 102 lockedly couples with the oscillating device. Coupling of the post 102 to the oscillating device may be desired during use of tool 100 as described more fully herein. The post 102 may be uncoupled from the oscillating device to allow for storage or for additional tips to be used. In examples, the oscillating tool may be a tool sold in home improvement stores, without modification. In other examples, the oscillating tool may be modified to provide, for example, a reconfigured connection mechanism to receive the post 102, increased control over RPMs, a reconfigured handle, or other components that allow for easier treatment of a patient.

The tool 100 may also comprise a head 108. The head 108 may be constructed at least partially of a polymeric material and/or one or more other materials, such as metals and/or woods. The head 108 may cover at least a portion of the distal end 104 of the post 102. The head 108 may also be coupled to the post 102. In examples, the head 108 may be releasably coupled to the post 102, which may allow a user to remove the head 108 from the post 102. Additionally, the polymeric material may include, but is not limited to, amorphous thermoplastic pellets and/or thermoplastic elastomers. The head 108 and the post 102 may be two separate components that are coupled together, or the head 108 and the post 102 may comprise a single component. The head 108 and post 102, whether constructed as separate components or a single component, may otherwise be described as a tip.

The head 108 may have a durometer sufficient to provide therapeutic treatment to a patient. The specific durometer of the head 108 may vary depending on the desired bodily area of treatment, the desired tissue to be treated, and a host of other factors including but not limited to the physical condition of the patient, patient age, patent pain tolerance, past medical history of the patient, and previous efficacy of myofascial release treatments. In an example, the durometer may be between approximately 0 A and approximately 150 A. As used herein, durometer is measured based on the Shore Hardness Scale. For example, the Shore A scale is used to define the durometer in this disclosure. However, it should be understood that other units of measuring hardness are not excluded from this disclosure. For example, a Shore A durometer of 60 A may equate to a roughly 90 durometer on the Shore 00 scale. Likewise, a Shore A durometer of 60 A may equate to a roughly 0 D durometer on the Shore D scale. Other units of hardness may also be used.

In an example, the durometer of the head 108 may be at least at least 0 A, at least 5 A, at least 10 A, at least 15 A, at least 20 A, at least 25 A, at least 30 A, at least 35 A, at least 40 A, at least 45 A, at least 50 A, at least 55 A, at least 60 A, at least 65 A, at least 70 A, at least 75, at least 80 A, at least 85 A, at least 90 A, at least 95 A, at least 100 A, at least 125 A, and/or at least 150 A. In an example, the durometer of the head 108 may be less than 150 A, less than 125 A, less than 100 A, less than 90 A, less than 80 A, less than 70 A, less than 60 A, less than 50 A, less than 40 A, less than 30 A, less than 20 A, less than 10 A, and/or less than 5 A. In an example, the durometer of the head 108 may be between approximately 0 A and approximately 150 A, between approximately 0 A and approximately 125 A, between approximately 0 A and approximately 100 A, between approximately 10 A and approximately 50 A, between approximately 15 A and approximately 40 A, between approximately 10 A and approximately 20 A, between approximately 20 A and approximately 30 A, between approximately 30A and approximately 40 A, between approximately 40 A and approximately 50 A, between approximately 50 A and approximately 60 A, and/or between approximately 60 A and approximately 70 A.

Treatment of a certain body part, a certain tissue type, or a certain patient may influence the durometer. By way of example, during treatment of a large muscle, such as a pectoral muscle, quadriceps, or hamstrings, or during treatment of a patient with a more athletic build, a higher durometer may be optimal to provide increased impact to the muscle during treatment. In this example, the durometer of the head 108 may be, for example, approximately 0 A or greater. In other examples, such as during treatment of smaller muscle groups, or for use on soft tissue, or for use on a patient with average muscle tone and having average health, the head 108 may have a durometer of, for example, approximately 0 A. In still other examples, such as during treatment of skeletal tissues, or certain tendons or ligaments, or for use on a fragile patient, the head 108 may have a durometer of, for example, approximately 0 A or less.

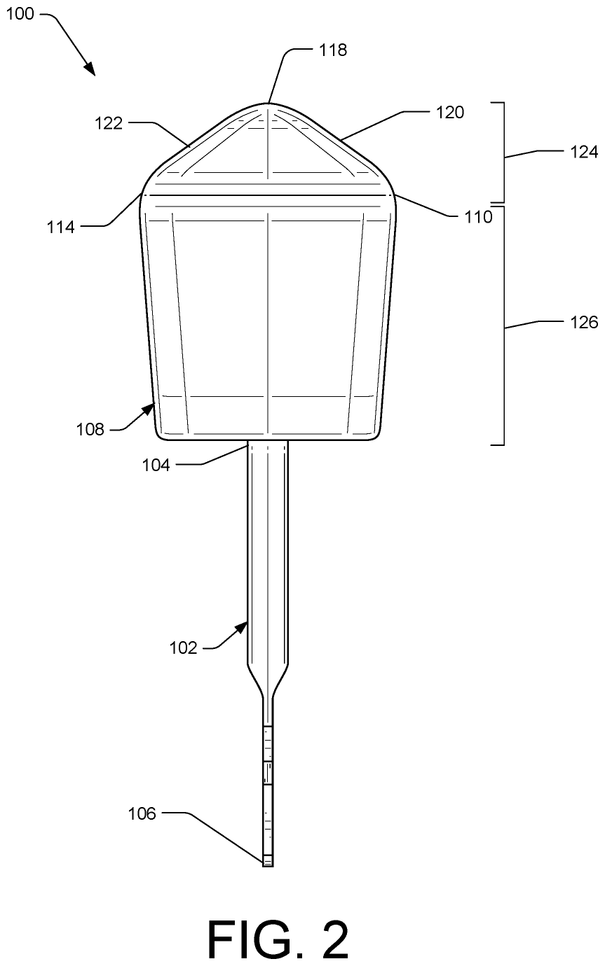

The head 108 may also comprise a variety of designs or configurations. For example, the head 108 depicted in FIG. 1 may include a first edge 110 situated on a first side 112 of the head 108 and a second edge 114 situated on a second side 116 (visible from FIG. 2, for example) of the head 108. In examples, the second side 116 of the head 108 may be opposite the first side 112 of the head 108. The head 108 may also include a third edge 118 situated approximately midway between the first edge 110 and the second edge 114. As used herein, “approximately” is meant to convey that the third edge 118 is positioned about and/or substantially near the midpoint between the first edge 110 and the second edge 114. In other examples, the third edge 118 may be positioned anywhere between the first edge 110 and the second edge 114. In examples, the third edge 118 may be positioned further from the proximal end 106 of the post 102 than the first edge 110 and/or the second edge 114. For example, as shown in FIG. 1, the third edge 118 is above the first edge 110 and the second edge 114 with respect to the post 102. In these examples, the third edge 118 may represent a top portion of the head 108. Additionally, in examples, the first edge 110, the second edge 114, and/or the third edge 118 may be at least partially concave such that, as the edge extends away from the axis corresponding to the post 102, the edge extends upward away from the proximal end 106 of the post 102. In examples, the third edge 118 may be sharp. In other examples, the third edge 118 may be blunt and/or rounded.

Additionally, the head may include a first surface 120 situated between the first edge 110 and the third edge 118, and a second surface 122 situated between the second edge 114 and the third edge 118. The first surface 120 may join the first edge 110 with the third edge 118. The second surface 122 may join the second edge 114 and the third edge 118. In examples, the first surface 120 and/or the second surface 122 may be at least partially concave. In examples, the first surface 120 may have a first distance between the first edge 110 and the third edge 118 of about 1 centimeter to about 8 centimeters. In other examples, the first distance may be between 0.1 centimeters to about 20 centimeters, at least 0.1 centimeters, or less than 20 centimeters. Additionally, the second surface 122 may have a second distance between the second edge 114 and the third edge 118 of about 1 centimeter to about 8 centimeters. In other examples, the second distance may be between 0.1 centimeters to about 20 centimeters, at least 0.1 centimeters, or less than 20 centimeters.

Additionally, or alternatively, the head 108 may be described as having a first portion 124 and a second portion 126. The first portion 124 may include the first edge 110, the second edge 114, the third edge 118, the first surface 120, and/or the second surface 122. The second portion 126 may be positioned between the first portion 124 and the proximal end 106 of the post 102, as shown in FIG. 1. While the first portion 124 is depicted in FIG. 1 as being shorter than the second portion 126, it should be understood that the first portion 124 may be shorter, longer, or the same size as the second portion 126. In examples, at least one side of the second portion 126 may be concave. As shown in FIG. 1, the second portion 126 of the head 108 has four sides (one side occluded) and each of the sides may be concave. In other examples, the sides may be straight, bowed, convex, and/or beveled.

The head 108 may be constructed of a polymeric material and/or a metallic material. When constructed at least partially of a polymeric material, the polymeric material may include platinum and a silicon-based polymer. The polymeric material may be selected for tensile strength and durometer depending on the application for which the tip will be used. When constructed at least partially of a metallic material, the metallic material may include titanium and/or another metal and/or composite that is approved for use on a patient. In examples, the polymeric material may have multiple durometers. For example, a given head 108 may include a dual-durometer wherein a first portion of the polymeric material has a first durometer while a second portion of the polymeric material has a second durometer. In examples, the higher durometer portion may be positioned at or near the post 102 while the lower durometer portion may be positioned near an exterior portion of the head 108, or vice versa. In still other examples, a given head 108 may include a durometer gradient, such that the durometer changes, gradually and/or in a stepwise fashion, from the post 102 to the exterior of the head 108. In still other examples, a first side of a given head 108 may have a first durometer while a second side and/or subsequent sides of the head 108 may have one or more other durometers that differ from the first durometer.

In examples, the first edge 110, the second edge 114, and/or the third edge 118 may be utilized for muscular and/or myofascial scraping and/or plowing therapies as described herein. Additionally, the first surface 120 and/or the second surface 122 may be utilized for compression and/or percussion therapies as described herein. A health care provider may switch, in examples back and forth, between utilizing one or more of the edges for scraping and/or plowing and utilizing one or more of the surfaces for compression and/or percussion without the need to switch tips and/or disable the oscillating device.

Additionally, while the units of measurement used herein include centimeters, those units of measurement are not exclusive. To the contrary, the metric equivalent of these measures is also included. Specifically, measurement of certain portions of the head 108 may be measured in terms of inches, in some examples.

Additionally, while not depicted in FIG. 1, the tool 100 may include a core. The core may comprise a component separate from the post 102, or the core may comprise a portion of the post 102 that is coupled to the head 108. The core may be shaped to secure the head 108 to the core, such as, for example, by one or more grooves that prohibit or hinder separation of the core from the head 108. In an example, the core may have locking and unlocking capabilities such that, when locked, the core is prohibited or hindered from disengaging from the head 108, and when unlocked, a user may disengage the core from the head 108.

When the core is a separate component from the post 102, the core may be secured to the post 102 through multiple attachment means, such as for example, tongue-in-groove designs, rivets, adhesive, threads, screws, and/or by a ball bearing system. In an example, using threaded attachment means, the core may be screwed on and off the post 102. In another example, using a ball bearing attachment means, the core may lockedly engage the post 102 when the ball bearings are engaged. An operator may exert opposing forces on the ball bearing system to disengage the ball bearings and allow the core to be removed from the post 102. The shape of the core may vary with, for example, the shape and design of the head 108. As described above with respect to FIG. 1, the head 108 may have a variety of designs and shapes. The core may have a substantially similar design and/or shape to a given head 108, or the shape of the core may be independent of the shape of a given head 108. In examples where the post 102 and the head 108 are a single component, the core may be absent or may define a portion of the head 108.

In examples, the head 108 may be configured as a cover that engages with the core. The head 108 may slip on to, or otherwise be sized to fit snugly on the core. In examples, the core may be made of at least a partially polymeric material, such as thermoplastic polypropylene, with a durometer that is similar to that of the head 108. In an example, the core may have a durometer that is greater than that of the head 108. The core may also be constructed at least partially of a sponge material, metal, and/or stone. In other examples, the tool 100 may not include a core, and instead the head 108 may lockedly engage with the post 102, such as by male and female threads.

FIG. 2 illustrates a side view of the example multi-purpose physiological treatment tool 100 shown in FIG. 1. The tool 100 may include some or all of the components described with respect to FIG. 1, such as a first edge 110, a second edge 114, a third edge 118, a first surface 120, a second surface 122, a first portion 124 of the head 104, a second portion 126 of the head 108, and/or a post 102. In examples, the third edge 118 may be situated approximately midway between the first edge 110 and the second edge 114. The third edge 118 may be positioned further from the proximal end 106 of the post 102 than the first edge 110 and/or the second edge 114. For example, as shown in FIG. 2, the third edge 118 is above the first edge 110 and the second edge 114 with respect to the post 102. In these examples, the third edge 118 may represent a top portion of the head 108. Additionally, in examples, the first edge 110, the second edge 114, and/or the third edge 118 may be at least partially concave such that, as the edge extends away from the axis corresponding to the post 102, the edge extends upward away from the proximal end 106 of the post 102.

Additionally, the first surface 120 may be situated between the first edge 110 and the third edge 118, and the second surface 122 may be situated between the second edge 114 and the third edge 118. The first surface 120 may join the first edge 110 with the third edge 118. The second surface 122 may join the second edge 114 and the third edge 118. In examples, the first surface 120 and/or the second surface 122 may be at least partially concave. In examples, the first surface 120 may have a first distance between the first edge 110 and the third edge 118 of about 1 centimeter to about 8 centimeters. In other examples, the first distance may be between 0.1 centimeters to about 20 centimeters, at least 0.1 centimeters, or less than 20 centimeters. Additionally, the second surface 122 may have a second distance between the second edge 114 and the third edge 118 of about 1 centimeter to about 8 centimeters. In other examples, the second distance may be between 0.1 centimeters to about 20 centimeters, at least 0.1 centimeters, or less than 20 centimeters.

Additionally, or alternatively, the head 108 may be described as having a first portion 124 and a second portion 126. The first portion 124 may include the first edge 110, the second edge 114, the third edge 118, the first surface 120, and/or the second surface 122. The second portion 126 may be positioned between the first portion 124 and the proximal end 106 of the post 102, as shown in FIG. 2. As shown in FIG. 2, the second portion 126 of the head 108 has four sides (one side occluded) and at least one of the sides may be tapered such that a distance from the post 102 to the exterior of the sides is shorter nearer the proximal end 106 of the post 102 than a distance from the post 102 to the exterior of the sides farther from the proximal end 106 of the post 102.

The head 108 may be constructed of the same or similar materials and/or may have the same or similar durometers as described with respect to FIG. 1. In examples, the first edge 110, the second edge 114, and/or the third edge 118 may be utilized for muscular scraping and/or plowing therapies as described herein. Additionally, the first surface 120 and/or the second surface 122 may be utilized for compression and/or percussion therapies as described herein. A health care provider may switch, in examples back and forth, between utilizing one or more of the edges for scraping and/or plowing and utilizing one or more of the surfaces for compression and/or percussion without the need to switch tips and/or disable the oscillating device. It should be understood that the head 108 as described herein may be utilized by the health care provider with just one tip and/or with just one surface, and/or in only one direction.

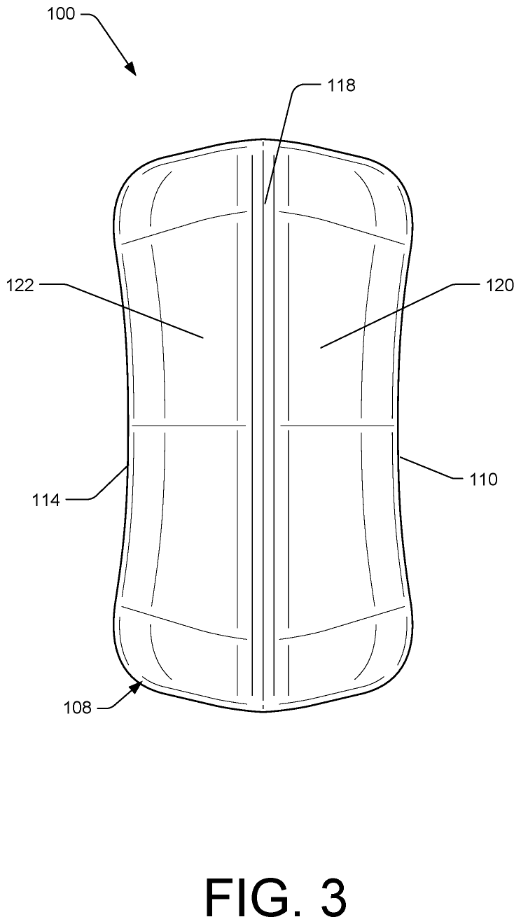

FIG. 3 illustrates a top view of the example multi-purpose physiological treatment tool 100 shown in FIG. 1. The tool 100 may include some or all of the components described with respect to FIG. 1, such as a head 108 having a first edge 110, a second edge 114, a third edge 118, a first surface 120, and/or a second surface 122. In examples, the third edge 118 may be situated approximately midway between the first edge 110 and the second edge 114. Additionally, in examples, the first edge 110, the second edge 114, and/or the third edge 118 may be at least partially concave such that, as the edge extends away from the axis corresponding to the post 102, the edge extends upward away from a post of the tool 100.

Additionally, the first surface 120 may be situated between the first edge 110 and the third edge 118, and the second surface 122 may be situated between the second edge 114 and the third edge 118. The first surface 120 may join the first edge 110 with the third edge 118. The second surface 122 may join the second edge 114 and the third edge 118. In examples, the first surface 120 and/or the second surface 122 may be at least partially concave. In examples, the first surface 120 may have a first distance between the first edge 110 and the third edge 118 of about 1 centimeter to about 8 centimeters. In other examples, the first distance may be between 0.1 centimeters to about 20 centimeters, at least 0.1 centimeters, or less than 20 centimeters. Additionally, the second surface 122 may have a second distance between the second edge 114 and the third edge 118 of about 1 centimeter to about 8 centimeters. In other examples, the second distance may be between 0.1 centimeters to about 20 centimeters, at least 0.1 centimeters, or less than 20 centimeters.

Additionally, or alternatively, a length of the third edge 118 may be longer or shorter than a length of the first edge 110 and/or the second edge 114. In examples, the length of the first edge 110 and the second edge 114 may be substantially similar to each other.

The head 108 may be constructed of the same or similar materials and/or may have the same or similar durometers as described with respect to FIG. 1. In examples, the first edge 110, the second edge 114, and/or the third edge 118 may be utilized for muscular scraping and/or plowing therapies as described herein. Additionally, the first surface 120 and/or the second surface 122 may be utilized for compression and/or percussion therapies as described herein, such as a person using the device to move tissue under the area being compressed and/or using a pin-and-stretch methodology. A health care provider may switch, in examples back and forth, between utilizing one or more of the edges for scraping and/or plowing and utilizing one or more of the surfaces for compression and/or percussion without the need to switch tips and/or disable the oscillating device.

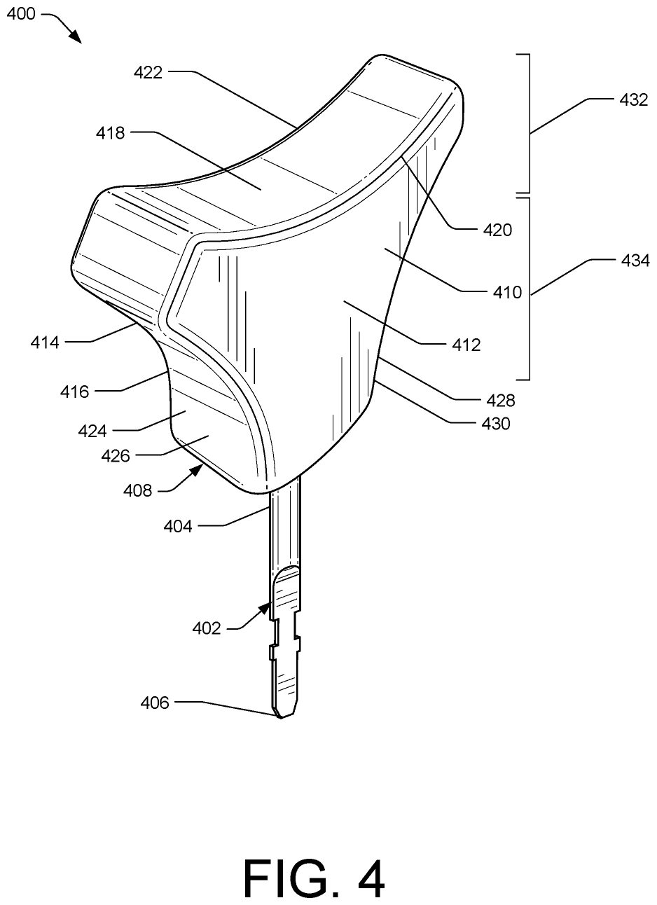

FIG. 4 illustrates a perspective view of another example multi-purpose physiological treatment tool 400. The tool 400 may include a post 402. The post 402 may have a distal end 404 and a proximal end 406. The proximal end 406 may be sized to be received by an oscillating device. In an example, the oscillating device may be any device that provides oscillating motion, such as, for example, a reciprocating saw, an oscillating saw, or sabre saw. The components and/or functionality of the oscillating device may be the same as or similar to the oscillating device described with respect to FIG. 1. The post 402 may be tooled to include grooves, indents, and other configurations to allow the proximal end 406 to be received within a particular oscillating device. The post 402 may be tooled such that, when received by the oscillating device, the post 402 lockedly couples with the oscillating device. Coupling of the post 402 to the oscillating device may be desired during use of tool 400 as described more fully herein. The post 402 may be uncoupled from the oscillating device to allow for storage or for additional tools 400 to be used. In examples, the oscillating tool may be a tool sold in home improvement stores, without modification. In other examples, the oscillating tool may be modified to provide, for example, a reconfigured connection mechanism to receive the post 402, increased control over RPMs, a reconfigured handle, a modified throw and/or stroke of the tool specific to the treatment being performed, or other components that allow for easier treatment of a patient.

The tool 400 may also comprise a head 408. The head 408 may be constructed at least partially of a polymeric material. The head 408 may cover at least a portion of the distal end 404 of the post 402. The head 408 may also be coupled to the post 402. In examples, the head 408 may be releasably coupled to the post 402, which may allow a user to remove the head 408 from the post 402. Additionally, the polymeric material may include, but is not limited to, amorphous thermoplastic pellets and/or thermoplastic elastomers. The head 408 and the post 402 may be two separate components that are coupled together, or the head 408 and the post 402 may comprise a single component. The head 408 and post 402, whether constructed as separate components or a single component, may otherwise be described as a tip.

The head 408 may have a durometer sufficient to provide therapeutic treatment to a patient. The specific durometer of the head 408 may vary depending on the desired bodily area of treatment, the desired tissue to be treated, and a host of other factors including but not limited to the physical condition of the patient, patient age, patent pain tolerance, past medical history of the patient, and previous efficacy of myofascial release treatments. In an example, the durometer may be between approximately −50 A and approximately 150 A. As used herein, durometer is measured based on the Shore Hardness Scale. For example, the Shore A scale is used to define the durometer in this disclosure. However, it should be understood that other units of measuring hardness are not excluded from this disclosure. For example, a Shore A durometer of 60 A may equate to a roughly 90 durometer on the Shore 00 scale. Likewise, a Shore A durometer of 60 A may equate to a roughly 0 D durometer on the Shore D scale. Other units of hardness may also be used. In an example, the durometer of the head 408 may be the same as or similar to the durometer options and/or ranges described with respect to FIG. 1. Treatment of a certain body part, a certain tissue type, or a certain patient may influence the durometer in the same or a similar manner as described with respect to FIG. 1.

The head 408 may also comprise a variety of designs or configurations. For example, the head 408 depicted in FIG. 4 may include a first surface 410 situated on a first side 412 of the head 408. The head 408 may also include a second surface 414 situated on a second side 416 of the head 408. In examples, the second side 416 of the head 408 may be opposite the first side 412 of the head 408. The head 408 may also include a third surface 418 situated between the first surface 410 and the second surface 414. In examples, the third surface 418 may be substantially perpendicular to at least one of the first surface 410 or the second surface 414. In other examples, at least a portion of the third surface 418 may be substantially perpendicular to at least one of the first surface 410 or the second surface 414. The third surface 418 may be at least partially concave. In these examples, the head 408 may resemble a three-dimensional “Y” shape.

Additionally, in examples, the head 408 may further include a fourth surface 424 proximate to the first surface 410, the second surface 414, and the third surface 418. In these examples, the fourth surface 424 may be on a third side 426 of the head 408. The fourth surface 424 may have a surface area that is less than at least one of the first surface 410, the second surface 414, and/or the third surface 418. Additionally, or alternatively, the head 408 may include a fifth surface 428 proximate to the first surface 410, the second surface 414, and/or the third surface 418. In these examples, the fifth surface 428 may be on a fifth side 430 of the head 408 opposite the fourth side 424 and the fifth surface 428 may have a surface area that is less than at least one of the first surface 410, the second surface 414, and/or the third surface 418. The fourth surface 424 and the fifth surface 428 may have substantially similar surface areas.

Additionally, in examples, the head 408 may include a first edge 420 situated between the first surface 410 and the third surface 418. The head 408 may also include a second edge 422 situated between the second surface 414 and the third surface 418. In examples, at least one of the first edge 420 or the second edge 422 is at least partially rounded and/or a right-angled edge. Additionally, in examples, the head may include a first portion 432 having the third surface 418, the first edge 420, and the second edge 422. The head 408 may also include a second portion 434 positioned between the first portion 432 and the proximal end 406 of the post 402. In these examples, the second portion 434 may have at least one side that is concave.

The head 408 may be constructed of a polymeric material and/or a metallic material. When constructed at least partially of a polymeric material, the polymeric material may include platinum and a silicon-based polymer. The polymeric material may be selected for tensile strength and durometer depending on the application for which the tip will be used. When constructed at least partially of a metallic material, the metallic material may include titanium and/or another metal and/or composite that is approved for use on a patient. In examples, the polymeric material may have multiple durometers. For example, a given head 408 may include a dual-durometer wherein a first portion of the polymeric material has a first durometer while a second portion of the polymeric material has a second durometer. In examples, the higher durometer portion may be positioned at or near the post 402 while the lower durometer portion may be positioned near an exterior portion of the head 408. In still other examples, a given head 408 may include a durometer gradient, such that the durometer changes, gradually and/or in a stepwise fashion, from the post 402 to the exterior of the head 408. In still other examples, a first side of a given head 408 may have a first durometer while a second side and/or subsequent sides of the head 408 may have one or more other durometers that differ from the first durometer.

In examples, the first edge 420 and/or the second edge 422 may be utilized for muscular and/or myofascial scraping and/or plowing therapies as described herein. Additionally, the third surface 418 may be utilized for compression and/or percussion therapies as described herein. A health care provider may switch, in examples back and forth, between utilizing one or more of the edges for scraping and/or plowing and utilizing one or more of the surfaces for compression and/or percussion without the need to switch tips and/or disable the oscillating device.

Additionally, while the units of measurement used herein include centimeters, those units of measurement are not exclusive. To the contrary, the metric equivalent of these measures is also included. Specifically, measurement of certain portions of the head 108 may be measured in terms of inches, in some examples.

Additionally, while not depicted in FIG. 4, the tool 400 may include a core. The core may comprise a component separate from the post 402, or the core may comprise a portion of the post 402 that is coupled to the head 408. The core may be shaped to secure the head 408 to the core, such as, for example, by one or more grooves that prohibit or hinder separation of the core from the head 408. In an example, the core may have locking and unlocking capabilities such that, when locked, the core is prohibited or hindered from disengaging from the head 408, and when unlocked, a user may disengage the core from the head 408.

When the core is a separate component from the post 402, the core may be secured to the post 402 through multiple attachment means, such as for example, tongue-in-groove designs, rivets, adhesive, threads, screws, and/or by a ball bearing system. In an example, using threaded attachment means, the core may be screwed on and off the post 402. In another example, using a ball bearing attachment means, the core may lockedly engage the post 402 when the ball bearings are engaged. An operator may exert opposing forces on the ball bearing system to disengage the ball bearings and allow the core to be removed from the post 402. The shape of the core may vary with, for example, the shape and design of the head 408. As described above with respect to FIG. 4, the head 408 may have a variety of designs and shapes. The core may have a substantially similar design and/or shape to a given head 408, or the shape of the core may be independent of the shape of a given head 408. In examples where the post 402 and the head 408 are a single component, the core may be absent or may define a portion of the head 408.

In examples, the head 408 may be configured as a cover that engages with the core. The head 408 may slip on to, or otherwise be sized to fit snugly on the core. In examples, the core may be made of at least a partially polymeric material with a durometer that is similar to that of the head 408. In an example, the core may have a durometer that is greater than that of the head 408. The core may also be constructed at least partially of a sponge material, metal, and/or stone. In other examples, the tool 400 may not include a core, and instead the head 408 may lockedly engage with the post 402, such as by male and female threads.

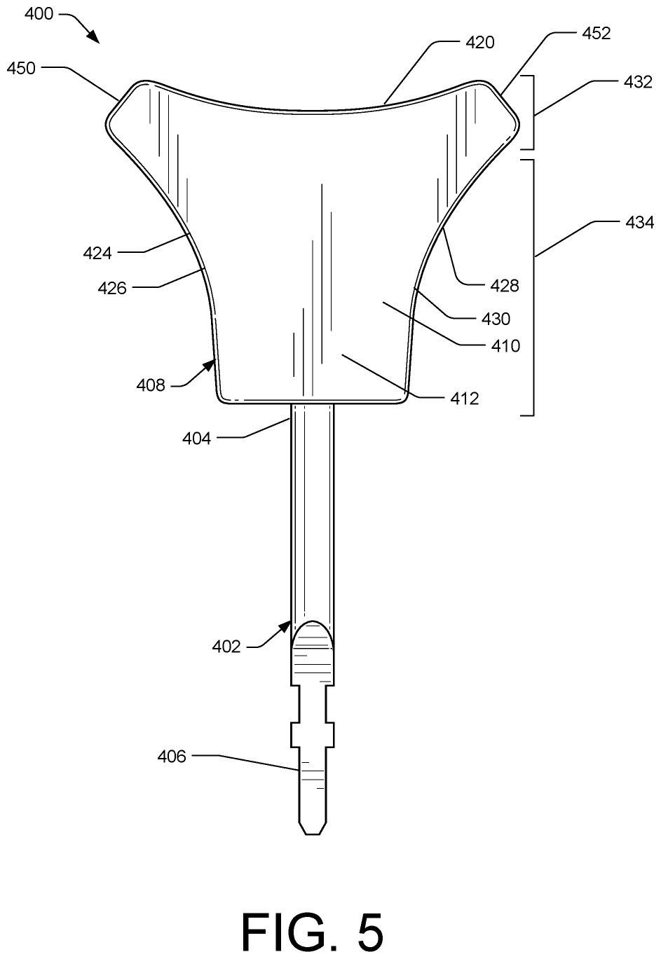

FIG. 5 illustrates a side view of the example multi-purpose physiological treatment tool shown in FIG. 4. The tool 400 may include some or all of the components described with respect to FIG. 4, such as a head 408 having a first edge 420, a first surface 410, a fourth side 426, a fifth side 430, and/or a post 402. For example, the head 408 depicted in FIG. 5 may include a first surface 410 situated on a first side of the head 408. The head 408 may also include a second surface (occluded) situated on a second side of the head 408. In examples, the second side of the head 408 may be opposite the first side of the head 408. The head 408 may also include a third surface situated between the first surface 410 and the second surface. In examples, the third surface may be substantially perpendicular to at least one of the first surface 410 or the second surface. In other examples, at least a portion of the third surface may be substantially perpendicular to at least one of the first surface 410 or the second surface. The third surface may be at least partially concave. In these examples, the head 408 may resemble a three-dimensional “Y” shape.

Additionally, in examples, the head 408 may further include a fourth surface proximate to the first surface 410, the second surface, and the third surface. In these examples, the fourth surface 424 may be on the third side 426 of the head 408. The fourth surface 424 may has a surface area that is less than at least one of the first surface 410, the second surface, and/or the third surface. Additionally, or alternatively, the head 408 may include a fifth surface 428 proximate to the first surface 410, the second surface, and/or the third surface. In these examples, the fifth surface 428 may be on a fifth side 430 of the head 408 opposite the fourth side 424 and the fifth surface 428 may have a surface area that is less than at least one of the first surface 410, the second surface, and/or the third surface. The fourth surface 424 and the fifth surface 428 may have substantially similar surface areas.

Additionally, in examples, the head 408 may include a first edge 420 situated between the first surface 410 and the third surface, which may work similarly to a knife edge. The head 408 may also include a second edge (occluded) situated between the second surface and the third surface. In examples, at least one of the first edge 420 or the second edge is at least partially rounded. Additionally, in examples, the head may include a first portion 432 having the third surface 418, the first edge 420, and the second edge 422. The head 408 may also include a second portion 434 positioned between the first portion 432 and the proximal end 406 of the post 402. In these examples, the second portion 434 may have at least one side that is concave.

The head 408 may be constructed of the same or similar materials and/or may have the same or similar durometers as described with respect to FIG. 4. In examples, the first edge 420 and/or the second edge may be utilized for muscular scraping and/or plowing therapies as described herein. Additionally, the third surface may be utilized for compression and/or percussion therapies as described herein. A health care provider may switch, in examples back and forth, between utilizing one or more of the edges for scraping and/or plowing and utilizing one or more of the surfaces for compression and/or percussion without the need to switch tips and/or disable the oscillating device.

Additionally, or alternatively, third surface may extend away from an axis corresponding to the post 402 in one or more directions. At or near the ends of the third surface a surface may be situated that is at an angle that differs from the angle of the third surface. These two terminal surfaces 450, 452 may have less surface area than the third surface.

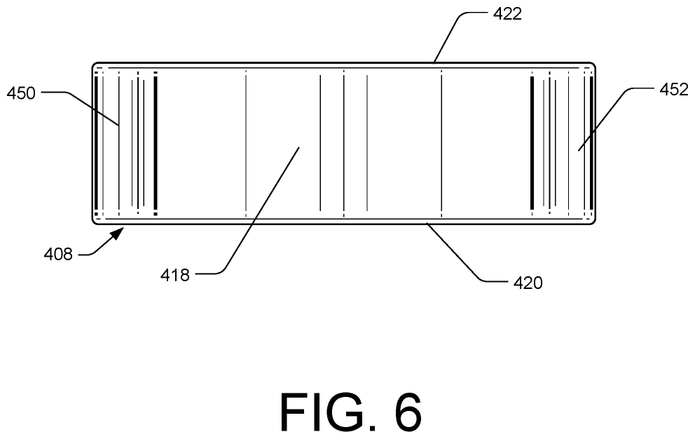

FIG. 6 illustrates a top view of the example multi-purpose physiological treatment tool shown in FIG. 4. The tool 400 may include some or all of the components described with respect to FIG. 4, such as a head 408 having a first edge 420, a second edge 422, the third surface 418, and/or the terminal surfaces 450, 452. For example, the head 408 depicted in FIG. 6 may include a third surface 418 situated between the first surface 410 and the second surface 414. In examples, the third surface 418 may be substantially perpendicular to at least one of the first surface 410 or the second surface 414. In other examples, at least a portion of the third surface 418 may be substantially perpendicular to at least one of the first surface 410 or the second surface 414. The third surface 418 may be at least partially concave. In these examples, the head 408 may resemble a three-dimensional “Y” shape.

Additionally, in examples, the head 408 may include the first edge 420 situated between the first surface 410 and the third surface 418. The head 408 may also include the second edge 422 situated between the second surface 414 and the third surface 418. In examples, at least one of the first edge 420 or the second edge 422 is at least partially rounded.

The head 408 may be constructed of the same or similar materials and/or may have the same or similar durometers as described with respect to FIG. 4. In examples, the first edge 420 and/or the second edge may be utilized for muscular scraping and/or plowing therapies as described herein. Additionally, the third surface may be utilized for compression and/or percussion therapies as described herein. A health care provider may switch, in examples back and forth, between utilizing one or more of the edges for scraping and/or plowing and utilizing one or more of the surfaces for compression and/or percussion without the need to switch tips and/or disable the oscillating device.

Additionally, or alternatively, third surface may extend away from an axis corresponding to the post 402 in one or more directions. At or near the ends of the third surface a surface may be situated that is at an angle that differs from the angle of the third surface. These two terminal surfaces 450, 452 may have less surface area than the third surface. These two terminal surfaces 450, 452 may be used to perform therapies other than percussion and/or scraping, such as pinpointed therapies.

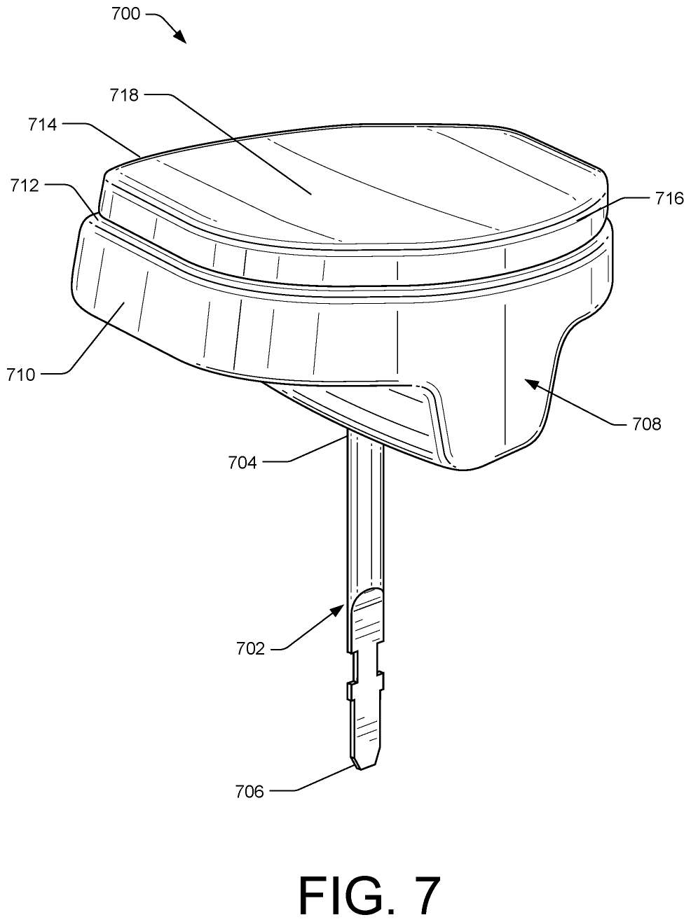

FIG. 7 illustrates a perspective view of another example multi-purpose physiological treatment tool 700. The tool 700 may include a post 702. The post 702 may have a distal end 704 and a proximal end 706. The proximal end 706 may be sized to be received by an oscillating device. In an example, the oscillating device may be any device that provides oscillating motion, such as, for example, a reciprocating saw, an oscillating saw, or sabre saw. The components and/or functionality of the oscillating device may be the same as or similar to the oscillating device described with respect to FIG. 1. The post 702 may be tooled to include grooves, indents, and other configurations to allow the proximal end 706 to be received within a particular oscillating device. The post 702 may be tooled such that, when received by the oscillating device, the post 702 lockedly couples with the oscillating device. Coupling of the post 702 to the oscillating device may be desired during use of tool 700 as described more fully herein. The post 702 may be uncoupled from the oscillating device to allow for storage or for additional tools 700 to be used. In examples, the oscillating tool may be a tool sold in home improvement stores, without modification. In other examples, the oscillating tool may be modified to provide, for example, a reconfigured connection mechanism to receive the post 702, increased control over RPMs, a reconfigured handle, or other components that allow for easier treatment of a patient.

The tool 700 may also comprise a head 708. The head 708 may be constructed at least partially of a polymeric material. The head 708 may cover at least a portion of the distal end 704 of the post 702. The head 708 may also be coupled to the post 702. In examples, the head 708 may be releasably coupled to the post 702, which may allow a user to remove the head 708 from the post 702. Additionally, the polymeric material may include, but is not limited to, amorphous thermoplastic pellets and/or thermoplastic elastomers. The head 708 and the post 702 may be two separate components that are coupled together, or the head 708 and the post 702 may comprise a single component. The head 708 and post 702, whether constructed as separate components or a single component, may otherwise be described as a tip.

The head 708 may have a durometer sufficient to provide therapeutic treatment to a patient. The specific durometer of the head 708 may vary depending on the desired bodily area of treatment, the desired tissue to be treated, and a host of other factors including but not limited to the physical condition of the patient, patient age, patent pain tolerance, past medical history of the patient, and previous efficacy of myofascial release treatments. In an example, the durometer may be between approximately −50 A and approximately 150 A. As used herein, durometer is measured based on the Shore Hardness Scale. For example, the Shore A scale is used to define the durometer in this disclosure. However, it should be understood that other units of measuring hardness are not excluded from this disclosure. For example, a Shore A durometer of 60 A may equate to a roughly 90 durometer on the Shore 00 scale. Likewise, a Shore A durometer of 60 A may equate to a roughly 0 D durometer on the Shore D scale. Other units of hardness may also be used. In an example, the durometer of the head 708 may be the same as or similar to the durometer options and/or ranges described with respect to FIG. 1. Treatment of a certain body part, a certain tissue type, or a certain patient may influence the durometer in the same or a similar manner as described with respect to FIG. 1.

The head 708 may also comprise a variety of designs or configurations. For example, the head 708 depicted in FIG. 7 may include a first portion 710 constructed of a rigid material. The first portion 710 may extend outwardly from the post 702 such that a width of the first portion is shorter than a length of the first portion 710. Additionally, a first side (also described herein as a top side 712) of the first portion 710 may be at least partially concaved. The width of the first portion 710 may be, for example, between about 1 centimeters and about 10 centimeters. The length of the first portion 710 may be, for example, between about 3 centimeters and about 50 centimeters. In examples, the width and length may be the same or substantially the same. In other examples, the width may be longer than the length. The rigid material may be polymeric and/or metallic and may have a durometer and/or hardness such that the first portion 710 does not easily bend and does not bend or “flap” when oscillated by an oscillating device. The first portion 710 may include one or more support members and/or components that assist in supporting the first portion 710 on the post 702.

The head 708 may also include a second portion 714 constructed on a pliant material, such as a polymeric material. The second portion 714 may be situated on at least a portion of the top side 712 of the first portion 710. In examples, the second portion 714 may be at least partially concaved. A perimeter or edge 716 of the second portion 714, in examples, may be at least partially rounded. The perimeter may vary in and/or out from the center of the tip 700 to increase and/or decrease the surface area of the second portion 714. The multi-durometer disclosure as described herein may also be applied to the head 708, such as where a harder durometer is present at the edge 716 than at the center of the second portion 714.

The first portion 710 may be thicker than the second portion 714. In other examples, the first portion 710 may be thinner than the second portion 714. In still other examples, the first portion 710 may have the same or substantially the same thickness as the second portion 714.

The second portion 714 of the head 708 may be constructed of a polymeric material and/or a metallic material. When constructed at least partially of a polymeric material, the polymeric material may include platinum and a silicon-based polymer. The polymeric material may be selected for tensile strength and durometer depending on the application for which the tip will be used. When constructed at least partially of a metallic material, the metallic material may include titanium and/or another metal and/or composite that is approved for use on a patient. In examples, the polymeric material may have multiple durometers. For example, a given head 708 may include a dual-durometer wherein a first portion of the polymeric material has a first durometer while a second portion of the polymeric material has a second durometer. In examples, the higher durometer portion may be positioned at or near the post 702 while the lower durometer portion may be positioned near an exterior portion of the head 408. In still other examples, a given head 708 may include a durometer gradient, such that the durometer changes, gradually and/or in a stepwise fashion, from the post 702 to the exterior of the head 708. In still other examples, a first side of a given head 708 may have a first durometer while a second side and/or subsequent sides of the head 708 may have one or more other durometers that differ from the first durometer.

In examples, the edge 716 may be utilized for muscular scraping and/or plowing therapies as described herein. Additionally, a top surface 718 of the second portion 714 may be utilized for circulatory therapies as described herein. A health care provider may switch, in examples back and forth, between utilizing one or more of the edges for scraping and/or plowing and utilizing the top surface 718 for circulatory therapy without the need to switch tips and/or disable the oscillating device.

Additionally, while the units of measurement used herein include centimeters, those units of measurement are not exclusive. To the contrary, the metric equivalent of these measures is also included. Specifically, measurement of certain portions of the head 108 may be measured in terms of inches, in some examples.

Additionally, while not depicted in FIG. 7, the tool 700 may include a core. The core may comprise a component separate from the post 702, or the core may comprise a portion of the post 702 that is coupled to the head 708. The core may be shaped to secure the head 708 to the core, such as, for example, by one or more grooves that prohibit or hinder separation of the core from the head 708. In an example, the core may have locking and unlocking capabilities such that, when locked, the core is prohibited or hindered from disengaging from the head 708, and when unlocked, a user may disengage the core from the head 708.

When the core is a separate component from the post 702, the core may be secured to the post 702 through multiple attachment means, such as for example, tongue-in-groove designs, rivets, adhesive, threads, screws, and/or by a ball bearing system. In an example, using threaded attachment means, the core may be screwed on and off the post 702. In another example, using a ball bearing attachment means, the core may lockedly engage the post 702 when the ball bearings are engaged. An operator may exert opposing forces on the ball bearing system to disengage the ball bearings and allow the core to be removed from the post 702. The shape of the core may vary with, for example, the shape and design of the head 708. As described above with respect to FIG. 7, the head 708 may have a variety of designs and shapes. The core may have a substantially similar design and/or shape to a given head 708, or the shape of the core may be independent of the shape of a given head 708. In examples where the post 702 and the head 708 are a single component, the core may be absent or may define a portion of the head 708.

In examples, the head 708 may be configured as a cover that engages with the core. The head 708 may slip on to, or otherwise be sized to fit snugly on the core. In examples, the core may be made of at least a partially polymeric material with a durometer that is similar to that of the head 708. In an example, the core may have a durometer that is greater than that of the head 708. The core may also be constructed at least partially of a sponge material, metal, and/or stone. In other examples, the tool 700 may not include a core, and instead the head 708 may lockedly engage with the post 702, such as by male and female threads.

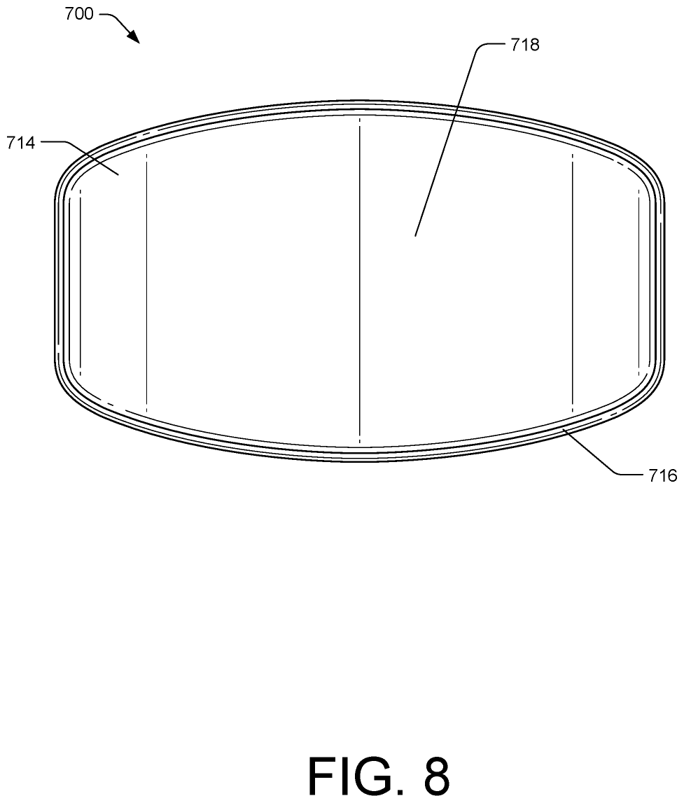

FIG. 8 illustrates a top view of the example multi-purpose physiological treatment tool shown in FIG. 7. The tool 700 may include some or all of the components described with respect to FIG. 7, such as a head 708 having a first portion 710 and a second portion 714. For example, the first portion 710 may extend outwardly from a post such that a width of the first portion 710 is shorter than a length of the first portion 710. Additionally, a first side (also described herein as a top side 712) of the first portion 710 may be at least partially concaved. The width of the first portion 710 may be, for example, between about 1 centimeters and about 10 centimeters. The length of the first portion 710 may be, for example, between about 3 centimeters and about 50 centimeters. In examples, the width and length may be the same or substantially the same. In other examples, the width may be longer than the length. The rigid material may be polymeric and/or metallic and may have a durometer and/or hardness such that the first portion 710 does not easily bend and does not bend or “flap” when oscillated by an oscillating device. The first portion 710 may include one or more support members and/or components that assist in supporting the first portion 710 on the post 702.

The head 708 may also include a second portion 714 constructed on a pliant material, such as a polymeric material. The second portion 714 may be situated on at least a portion of the top side 712 of the first portion 710. In examples, the second portion 714 may be at least partially concaved. A perimeter or edge 716 of the second portion 714, in examples, may be at least partially rounded.

The first portion 710 may be thicker than the second portion 714. In other examples, the first portion 710 may be thinner than the second portion 714. In still other examples, the first portion 710 may have the same or substantially the same thickness as the second portion 714.

The head 708 may be constructed of the same or similar materials and/or may have the same or similar durometers as described with respect to FIG. 7. In examples, the edge 718 may be utilized for muscular scraping and/or plowing therapies as described herein. Additionally, the top surface 718 may be utilized for circulatory therapies as described herein. A health care provider may switch, in examples back and forth, between utilizing one or more of the edges for scraping and/or plowing and utilizing the top surface 718 for circulatory therapies without the need to switch tips and/or disable the oscillating device.

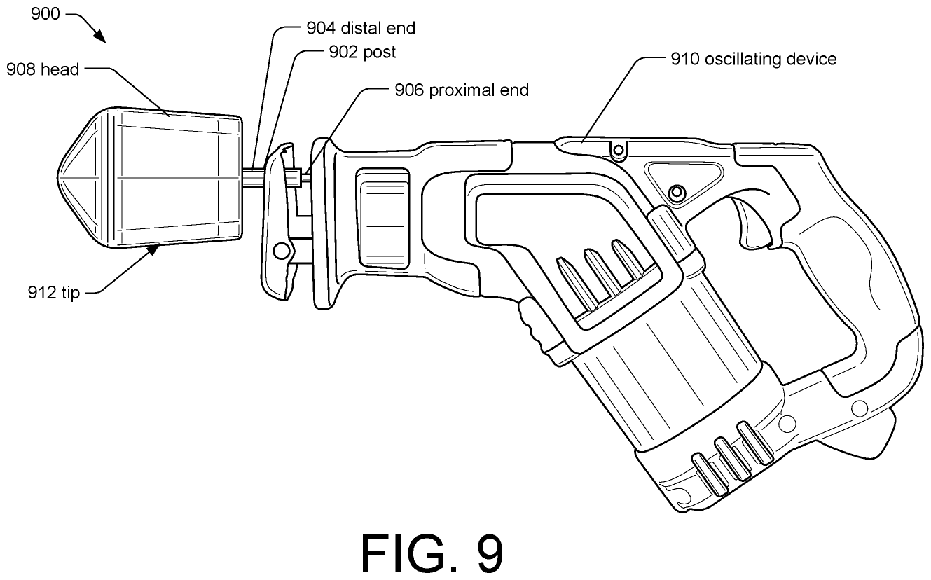

FIG. 9 illustrates a side view of an example treatment apparatus 900. The apparatus 900 may comprise a post 902 having a distal end 904 and a proximal end 906, and a head 908. The apparatus 900 may also comprise an oscillating device 910, and the post 902 and head 908 may collectively represent a tip 912. As shown in FIG. 9, the proximal end 906 of the post 902 may be sized to be received by the oscillating device 910. The proximal end 906 of the post 902 may contain grooves and/or slots configured to allow the post 902 to fit into a common oscillating device such as, for example, a reciprocating device. In other examples, the receptacle portion of the oscillating device 910 may be configured to specifically receive post 902 as described herein.

In examples, the oscillating device 910 may oscillate the post 902 in a substantially linear motion from, for example, approximately 1 RPM to approximately 3,000 RPM. In other examples, the RPM may be alternatively defined as strokes per minute. In an example, the oscillating device 910 may oscillate at more than 3,000 RPM. For example, the oscillating device may oscillate at at least 3,000 RPM, at least 3,500 RPM, at least 4,000 RPM, at least 4,500 RPM, at least 5,000 RPM, or more. The post 902 may be tooled to include grooves, indents, and other configurations to allow the proximal end 906 to be received within the oscillating device 910. The post 902 may be tooled such that, when received by the oscillating device 910, the post 902 lockedly couples with the oscillating device 910. Coupling of the post 902 to the oscillating device 910 may be desired during use of apparatus 900 as described more fully herein. The post 902 may be uncoupled from the oscillating device 910 to allow for storage or for additional tips 912 to be used. In an example, the oscillating tool 910 may be a tool sold in home improvement stores, without modification. In other examples, the oscillating tool 910 may be modified to provide, for example, a reconfigured connection mechanism to receive the post 902, increased control over RPMs, a reconfigured handle, or other components that allow for easier treatment of a patient.

The apparatus 900 may be used in connection with a variety of tips 912, such as, for example, tool 100, tool 400, and/or tool 700. The tips 912 may be interchangeable, such that, for example, tool 100 can be initially received in the oscillating device 910 and can be removed and replaced with, for example, tool 400, which could be removed and replaced with, for example, tool 700.

The tips 912 may also be rotatable about the post 902, such that the tip 912 and/or the post 902 and/or the head 908 may rotate. In an example, the tips 912 may be freely rotatable by providing a turning force in the desired direction of rotation. A certain threshold of force may be required to rotate the tips 912. In an example, the tips 912 may include one or more notches that may allow the tips 912 to snap into differing rotatable positions when received by the oscillating device 910. In an example, the tips 912 may include one or more ball bearing assemblies that may allow the tips 912 to rotate when the ball bearings are disengaged, but may not allow the tips 912 to rotate when the ball bearings are engaged. During a treatment session, the health care provider may rotate the tip 912 received by the oscillating device 910 to promote treatment of a given area of the body.

As described in FIGS. 1-9, various components of the tools 100, 400, and 700, and the apparatus 900, have been described as components of certain examples of the multi-purpose physiological treatment tools and apparatuses described herein. However, it should be understood that in some examples each component described herein may be included in any or all of the tools 100, 400, and/or 700, and the apparatus 900, and the inclusion of a component in one example does not exclude its potential inclusion in other examples. Additionally, multiples of the components of the tools 100, 400, and/or 700, and the apparatus 900, may also be included.

The tools and apparatuses described in FIGS. 1-9 may alleviate some or all of the shortcomings of current myofascial release techniques by decreasing physical effort required by a health care professional, decreasing pain to the patient, and hindering the ability of the patient's reflexes to work against the health care provider. Additionally, the myofascial release tools and methods described herein provide treatment for a wider range of body tissues and parts than could be achieved through conventional myofascial release techniques, diversifying myofascial release applicability.

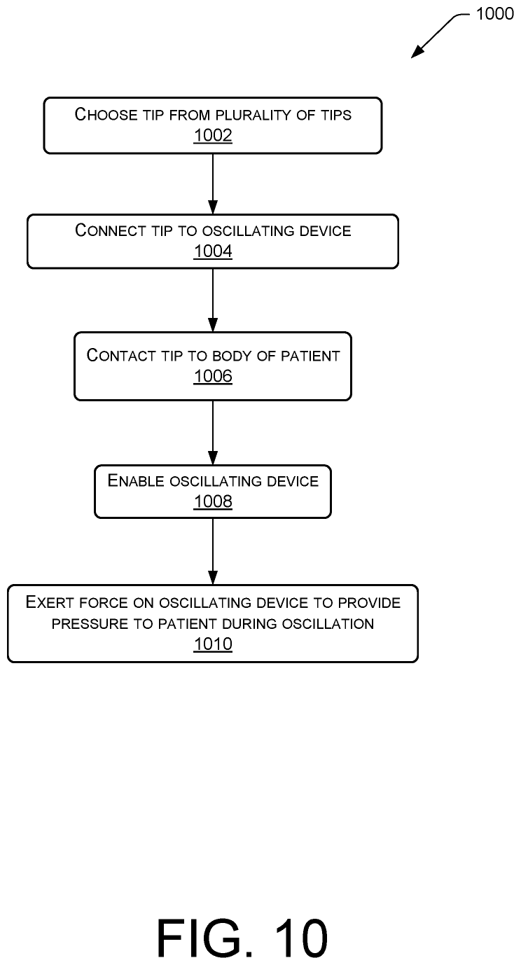

Also disclosed herein are methods of using a myofascial release tool, such as those described herein. FIG. 10 illustrates a flow diagram of an example process 1000 by which a multi-purpose physiological treatment tool may be utilized. Method 1000 is illustrated as a logical flow graph. The order in which the operations or steps are described is not intended to be construed as a limitation, and any number of the described operations can be omitted, modified, or combined in any order and/or in parallel to implement method 1000.

In an example, a process 1000 of using multi-purpose physiological treatment tools may include oscillating at least one of multiple tips on a desired portion of a patient's body. The oscillating may be accomplished by operation of an oscillating device with a tip received by the oscillating device.

At block 1002, the process 1000 may include choosing a tip from the multiple tips that is designed for or otherwise could be used on a specific portion of the patient's body and/or for treatment of specific tissue (e.g., muscle, tendon, ligament, etc.).

At block 1004, method 1000 may include connecting the chosen tip to the oscillating device. The tips chosen by the health care provider may comprise a variety of designs and configurations. For example, the tip may be designed as described above with respect to the tool 100. The tip may be additionally, or alternatively, designed as described above with respect to the tool 400. The tip may additionally, or alternatively, designed as described above with respect to the tool 700.

At block 1006, the process 1000 may include contacting the tip to the body of the patient. The health care provider may place the tip over the desired portion of the patient's body such that all or a portion of the desired body part rests in a concaved surface and/or edge portion of the tip. This configuration of the tip may allow the health care provider to move the tip up and down a muscle while keeping the tip from vibrating off of the body part of interest. The process 100 may also include, in examples, applying a lubricant, such as an oil like coconut oil and/or massage oil, to the head of the tip.

At block 1008, the process 1000 may include enabling the oscillating device such that oscillation of the tip occurs.

At block 1010, the process 1000 may include exerting a certain amount of force during oscillation depending on the chosen tip and desired therapeutic effect. The health care provider may change contact positions of the tip with the patient's body during a treatment session between an edge portion of the tip and a surface portion of the tip, as described elsewhere herein. The health care provider may also change tips during a treatment session to treat additional areas of the body and/or additional tissues. The health care provider may also rotate the tips during a treatment session to treat additional areas of the body or for in-treatment adjustment to increase efficacy of the treatment. The tips may comprise varying durometers and designs and be interchangeable without substantial effort or time. It should be understood that the movement of the tip on the patient's body may be in a pushing and/or a pulling motion, in examples.

The exertion of force as described herein may be performed in multiple ways. For example, when a plowing technique is employed, the plowing may include the turning and/or scraping of tissue to mobilize fluid, expelling fluid from one section and/or compartment of the human body to another for the advantage of creating circulation to prepare tissue for activity. In these and other examples, fluid and/or tissue may be expelled from the treatment area and may create a vacuum that may promote new and/or healthy and/or helpful fluid and/or tissue to enter the treatment area. In this process, the mechanoreceptors may be stimulated and excited, which may prepare the nervous system for performance.

A health care provider may use the processes described herein for a single treatment or for a treatment regimen, which may include use of one or many of the tips described herein. The length of treatment, pressure used during treatment, choice of tip, oscillation speed, and choice of body part and/or tissue to treat will vary depending on the health of a given patient and treatment goals.

The term “about” or “approximate” as used in the context of describing a range of volume, pressure, or temperature is to be construed to include a reasonable margin of error that would be acceptable and/or known in the art.

The present description uses specific numerical values to quantify certain parameters relating to the innovation, where the specific numerical values are not expressly part of a numerical range. It should be understood that each specific numerical value provided herein is to be construed as providing literal support for a broad, intermediate, and narrow range. The broad range associated with each specific numerical value is the numerical value plus and minus 60 percent of the numerical value, rounded to two significant digits. The intermediate range associated with each specific numerical value is the numerical value plus and minus 30 percent of the numerical value, rounded to two significant digits. The narrow range associated with each specific numerical value is the numerical value plus and minus 15 percent of the numerical value, rounded to two significant digits. These broad, intermediate, and narrow numerical ranges should be applied not only to the specific values, but should also be applied to differences between these specific values.

Furthermore, this disclosure provides various examples, as described and as illustrated in the figures. However, this disclosure is not limited to the examples described and illustrated herein, but can extend to other examples, as would be known or as would become known to those skilled in the art. Reference in the specification to “one example,” “this example,” “these examples” or “some examples” means that a particular feature, structure, or characteristic described is included in at least one example. The appearances of these phrases in various places in the specification are not necessarily all referring to the same example, nor are they mutually exclusive. That is, features, structures, and characteristics of one example may, but need not necessarily, be combined with features, structures, and/or characteristics of one or more other examples.

Although the disclosure describes examples having specific structural features and/or methodological acts, it is to be understood that the claims are not necessarily limited to the specific features or acts described. Rather, the specific features and acts are merely illustrative of some examples that fall within the scope of the claims of the disclosure.

What is claimed is:

1. A tool, comprising:
a post, the post having a distal end and a proximal end, the proximal end sized to be received by an oscillating tool; and
a head covering at least a portion of the distal end of the post and coupled to the post, the head having:
a first edge situated on a first side of the head;
a second edge situated on a second side of the head, the second side of the head opposite the first side of the head;
a third edge situated approximately midway between the first edge and the second edge, the third edge positioned further from the proximal end of the post than the first edge and the second edge, the third edge being at least partially concave;
a first surface situated between the first edge and the third edge; and
a second surface situated between the second edge and the third edge.

2. The tool of claim 1, wherein:
the first edge is at least partially concave; and
the second edge is at least partially concave.

3. The tool of claim 1, wherein:
the first surface has a first distance between the first edge and the third edge of about 1 centimeter to about 8 centimeters; and
the second surface has a second distance between the second edge and the third edge of about 1 centimeter to about 8 centimeters.

4. The tool of claim 1, wherein the head is constructed at least partially of a polymeric material having a durometer of about 0 A to about 50 A.

5. The tool of claim 1, wherein:
the head includes a first portion having the first edge, the second edge, the third edge, the first surface, and the second surface; and
the head includes a second portion positioned between the first portion and the proximal end of the post, the second portion have at least one side that is concave.

6. The tool of claim 1, wherein the head is constructed of a polymeric material that includes platinum.

7. The tool of claim 1, wherein:
the head is constructed of a polymeric material;
a first portion of the polymeric material has a first durometer; and
a second portion of the polymeric material has a second durometer, the first durometer differing from the second durometer.

8. A tool, comprising:
a post, the post having a distal end and a proximal end, the proximal end sized to be received by an oscillating tool; and
a head covering at least a portion of the distal end of the post and coupled to the post, the head having:
a first surface situated on a first side of the head;
a second surface situated on a second side of the head, the second side of the head opposite the first side of the head;
a third surface situated between the first surface and the second surface, the third surface being substantially perpendicular to at least one of the first surface or the second surface, the third surface being at least partially concave;
a first edge situated between the first surface and the third surface; and
a second edge situated between the second surface and the third surface.

9. The tool of claim 8, wherein:
the first edge is at least partially rounded; and
the second edge is at least partially rounded.

10. The tool of claim 8, wherein the head further includes:
a fourth surface proximate to the first surface, the second surface, and the third surface, the fourth surface on a third side of the head and having a surface area less than at least one of the first surface, the second surface, or the third surface; and
a fifth surface proximate to the first surface, the second surface, and the third surface, the fifth surface on a fourth side of the head opposite the third side and having a surface area less than at least one of the first surface, the second surface, or the third surface.

11. The tool of claim 8, wherein the head is constructed at least partially of a polymeric material having a durometer of about 0 A to about 50 A.

12. The tool of claim 8, wherein:
the head includes a first portion having the third surface, the first edge, and the second edge; and
the head includes a second portion positioned between the first portion and the proximal end of the post, the second portion having at least one side that is concave.

13. The tool of claim 8, wherein the head is constructed of a polymeric material that includes platinum.

14. The tool of claim 8, wherein:
the head is constructed of a polymeric material;
a first portion of the polymeric material has a first durometer; and
a second portion of the polymeric material has a second durometer, the first durometer differing from the second durometer.

15. A tool, comprising:
a post, the post having a distal end and a proximal end, the proximal end sized to be received by an oscillating tool; and
a head covering at least a portion of the distal end of the post and coupled to the post, the head having:
a first portion constructed of a rigid material, the first portion extending outwardly from the post such that a width of the first portion is shorter than a length of the first portion, a side of the first portion being concaved; and
a second portion constructed of a pliant polymeric material, the second portion coupled to the first portion on the side of the first portion, the second portion being concaved.

16. The tool of claim 15, wherein the second portion has a durometer of about 0 A to about 50 A.

17. The tool of claim 15, wherein the second portion includes at least one edge on an exterior portion of the second portion.

18. The tool of claim 15, wherein a perimeter of the second portion includes a rounded edge.

19. The tool of claim 15, wherein the pliant polymeric material that includes platinum.

20. The tool of claim 15, wherein:
a first portion of the pliant polymeric material has a first durometer; and
a second portion of the pliant polymeric material has a second durometer, the first durometer differing from the second durometer.
